(19) United States
(12) Patent Application Publication
(10) Pub. No.: US 2017/0280682 A1
(43) Pub. Date: Oct. 5, 2017

(54) EQUINE EXERCISE BOOT ASSEMBLY AND ICE SPA

(71) Applicant: Monty L. Ruetenik, Clear Lake City, TX (US)

(72) Inventor: Monty L. Ruetenik, Clear Lake City, TX (US)

(21) Appl. No.: 15/630,803

(22) Filed: Jun. 22, 2017

Related U.S. Application Data
(63) Continuation-in-part of application No. 14/528,703, filed on Oct. 30, 2014.
Application No. 14/528,703 is a continuation-in-part of application No. 14/465,006, filed on Aug. 21, 2014, now Pat. No. 9,055,732.
(60) Provisional application No. 61/898,270, filed on Oct. 31, 2013.
(60) Provisional application No. 62/040,563, filed on Aug. 22, 2014.

(51) Int. Cl. A01K 13/00; A01K 15/02; A01K 29/00

(52) U.S. Cl. CPC A01K 13/007; A01K 29/00; A01K 15/027

(57) ABSTRACT

A boot assembly and method that simulates, in a static equine animal (stalled or hauled), the natural mechanical action of walking or other gaited exercise. The assembly has a boot, containing a shock absorbing pad that is fitted with one or more pulsing bladders disposed under or inside the shock absorbing pad. Pressuring and relaxing the pulsing bladder in the bottom of the boot rhythmically pushes against the sole and frog and against the toe of the equine hoof in much the same way that the hoof is exercised when the animal is moving. The pulsing action helps stimulate blood flow through the hoof and is beneficial to shod, injured, and transported horses. The assembly may be fitted on one or more hooves, and may be automated to provide timing and sequencing to simulate different gaits of the animal. In some aspects, the assembly is disposed in an ice boot or ice spa boot to also provide cryotherapy as well as simulated exercise.

### CROSS REFERENCE TO RELATED APPLICATIONS

This application is a Continuation-in-Part application of U.S. application Ser. No. 14/528.703 filed Oct. 30, 2014 and claims benefit of U.S. Provisional Application Ser. No. 61/898.270 filed Oct. 31, 2013, and is also a Continuation-in-Part of U.S application No. 14/465.006 filed Aug. 21, 2014. now U.S. Pat. No. 9,055,732 and which claims benefit of U.S. Provisional application Ser. No. 62/040.563 filed Aug. 22, 2014, the disclosures and figures of which are incorporated herein by reference for all purposes.

### BACKGROUND

Field of Invention

This invention relates to an equine boot assembly and method that simulates the natural mechanical action of walking exercise in a static equine (as when stalled and/or transported) and which is adapted for applying coolant to an equine leg and hoof.

### Background

It is well established that when equine animals arc stabled, transported or suffering from exercise stress or laminitis benefit from exercise, cryotherapy and standing support that allows them to achieve natural balance to self-relieve pain in the legs and hooves.

As explained in U.S. Pat. No. 8,291,683. Oct. 23, 2012 (the entire discourse and figures of which are incorporated herein by reference) “Walking causes natural compression and release of the sole of the equine hoof. As the hoof strikes the ground, the walls of the hoof expand slightly to allow the frog of the hoof to be compressed. When the hoof is raised, the frog returns to its resting position. This action on the frog of the hoof acts as a secondary blood pump to circulate blood to all parts of the hoof, as well as to other extremities. In many cases, post-surgical walking is not only an equine's natural way of healing, but is essential for a horse's recovery and wellbeing. It is often necessary to walk a horse several times a day for days to weeks after surgery. Such exercise can be both expensive and time consuming.”

“The importance of the hoof as a blood pump is not limited to injury and healing, however. Horses that are transported or stalled, especially in stalls with hard floor surfaces. suffer from lack of hoof and leg exercise. In many cases, owners will stop and exercise their horses as often as every four hours thus greatly extending travel time and inconvenience. Although recovery needs to be rapid in these hauled performance horses to restore natural circulation of blood to the extremities, and to return the horse to performance condition, horses transported long distances may need significant recovery time to regain peak performance. Unfortunately, attempts to achieve this rapid recovery commonly require the use of excessive medication, including pain killers and legal stimulants.”

It is also known that cold therapy (cryotherapy) is helpful in preventing injury in animals before and after stressful activity and especially in treating laminitis. As quoted in an article in The Chronicle of the Horse, “Cold therapy is used by every international team at every competition,” said Merrick. “Without a doubt, cold therapy got some of our team horses through. It's called high performance for a reason, and the demands on the horses are high. On the international stage where therapeutic medication is not allowed to help with recovery or minor pain relief, icing is the primary way to maintain the horses' comfort and performance.” Jennifer M. Keeler, Ice Down To Ride On, The Chronicle of the Horse; Sep. 9, 2013 (www.chronofhorse.com). Also see E. R. Hunt, Response of Twenty-seven Horses with Lower leg Injuries to Cold Spa Bath Hydrotherapy: Journal of Equine Veterinary Science; Volume 21, Number 4, 2001, p 188-193. The use of seawater and magnesium salts in a cold therapy is also well known as beneficial in healing and recovery of stress and other injuries. See U.S. provisional application 62/040,563. And as disclosed in U.S. Pat. No. 8,291,683, issued Oct. 23, 2012: “Laminitis is generally thought to result from an imbalance in the horse's internal system. For example, an injury or upset to some part of the body is combated by the circulatory system as blood rushes to the injured area. The momentary reduction in blood flow deprives the capillaries which feed the lamina. The lamina is the “velcro” that attaches the bone to the hoof wall. In the brief time the lamina lacks sufficient blood flow, the capillaries begin to die and the “Velcro” attachment is weakened. The deep flexor tendon is attached to the bottom (palmar surface) of the coffin bone. This tendon is an extension of a muscle which reacts to the pain of the tearing lamina. As the muscle contracts, the tendon is in tension and pulls on the coffin bone. Once this pain cycle is established, it must be broken before healing can begin.” “While lameness, especially that caused by laminitis is difficult to cure, it is possible to relieve some of the pressure and pain by use of proper trimming, shoes or boots that allow the horse to find a comfortable position and to relieve unnecessary pressure on a lame hoof. Such relief is often essential to an eventual cure.”

The present invention is extended and clarifying disclosure of embodiments of the invention described in U.S. Pat. No. 8,291,683—embodiments comprising exercise simulation therapies combined with cryotherapy and means for achieving natural balance. A stabled horse using the system and method of this invention will think it is walking in a soft bed of sand in a cold mountain stream.

### SUMMARY

The present invention includes an equine boot assembly and method that simulates the natural mechanical actions and benefits of walking (or other gaits) in a stationary animal that are improvements and/or extensions of the simulated gel walker systems of the systems described in U.S. Pat. No. 8,291,683, Oct. 23, 2013. In this invention, two or more (preferably dual) bladders are included in each hoof assembly to provide more flexibility in simulation of a natural gait and in allowing more customized treatment modalities. In additional embodiments, the present invention incorporates into the simulated exercise modality means for cryotherapy and an optional rocker attachment to allow an equine to achieve natural balance.

### DESCRIPTION OF THE FIGURES

FIG. 1 is a schematic of a flow diagram of an embodiment of the invention.

FIG. 2 is a schematic of a flow diagram of another embodiment of the invention.

FIG. 3A is a perspective view of a pulser bladder of an embodiment of the invention.

FIG. 3B is a perspective view of a pulser bladder of an embodiment of the invention.

FIG. 4 is a perspective view of partially overlapped dual pulser bladders of an embodiment of the invention.

FIG. 5 is a plan view of a orthotic pad with dual bladders disposed beneath.

FIG. 6 is a perspective view of a boot assembly of an embodiment of the invention showing air tubes into the pulsing means.

FIG. 7 is a perspective view of an ice boot of an embodiment of the invention.

FIG. 8 is a side view of a boot sole plate and walls with straps for connecting holding means.

FIG. 9 is a top view of a boot of an embodiment of the invention showing holding means connecting structures.

FIG. 10 is a perspective view of a structure of the invention on an equine leg.

FIG. 11 is a perspective view of a holding structure of an embodiment of the invention.

FIG. 12 is also a perspective view of a holding structure of an embodiment of the invention.

FIG. 13 is a perspective view of the holding structure on an equine leg.

FIG. 14 is a perspective view of an orthotic pad of an embodiment of the invention.

FIG. 15 is a perspective view of an orthotic pad of an embodiment of the invention.

FIG. 16 is a side view of an orthotic pad of an embodiment of the invention showing optional low density particles in the body of the orthotic pad.

FIG. 17 is a front view of an orthotic pad of an embodiment of the invention.

### DETAILED DESCRIPTION

For horses, walking is more than mere exercise; it is also therapeutic. In walking or running, the frog of the hoof operates in concert with the rest of the hoof to act as a secondary blood pump to circulate blood to the extremities and return blood to the heart. For post-surgical recovery, easing of the pain caused by laminitis, and fatigue prevention, this increased blood flow is very beneficial, if not necessary. However, it is not always possible or economical to walk (or perform some other means of exercise) a horse as much or as often as needed. Additionally, while walking is necessary for the general well-being of equines, it cannot be accomplished during hauling or when the animal is stalled. The addition of cryotherapy or icing the equine legs with the simulated exercise is especially beneficial.

The present invention is, in several embodiments, a boot assembly and method that simulates the natural mechanical actions and benefits of walking (or other gaits) in a stationary animal that are improvements and/or extensions of the simulated gel walker systems of the system described in U.S. Pat. No. 8,291,683, Oct. 23, 2013 the disclosure and figures are incorporated herein by reference in their entirety for all purposes. In additional embodiments, the present invention incorporates into the simulated exercise modality means for cryotherapy and a rocker attachment to allow an equine to achieve a more natural balance.

The objective of this invention is an electronically-controlled pressurization system that will simulate natural equine gaits in an equine boot equipped with gel orthotic pads and pulsing chambers. In use, the equine will generally be equipped with one to four boots (one per hoof). The control system in some embodiments, will cyclically and sequentially pressurize two or more (dual pads preferred) in each boot to mimic the natural gaits of the horse. The goal of this therapy is to prevent or treat negative consequences of confinement, and provide some of the benefits of walking therapy in horses who cannot be exercised. It is especially beneficial as a part of treatment regimen for equine laminitis and when combined with iceing. The improvements in this aspect of the invention over that described in U.S. Pat. No. 8,291,683 is, inter alia, the use of dual pads disposed in or under elastomeric gel pads and particularly the use of the system in an ice boot for cold therapy. In some embodiments and the pressure pump and control center will be suspended from a carrier suspended on the equine's back possibly with a surcingle, harness or from suspended from a ceiling or other overhead structure.

The invention exists in three broad embodiments 1) the simulated walking system with two or more pulsing bladders, 2) the simulated walking system with a rocker attachment for the boot sole and 3) the simulated walking system disposed in an ice boot or ice spa.

In all embodiments the system will cyclically pressurize each of one or more elastomeric pads in each boot system to simulate typical equine walking gait. Preferably, the system will be capable of simulating both walking and trotting gaits and other sequences designed by the user. The system is, in one embodiment, light weight and battery operated so that the entire apparatus—controller, valves, air pump, and compressed air holding tank (if needed), is completely portable and can be carried on the horse giving complete freedom of movement. The maximum desirable weight of a portable system is about twenty (20) to forty (40) pounds. Battery time is, ideally, about 1-6 plus hours. The batteries can be equipped for wireless recharging. The system is sufficiently durable and energy efficient to maintain continuous operation for a reasonable amount of time, for example 0.5 to 4 hours. In some embodiments, the entire pumping means, valves and control panel may be attached to a surcingle or overgirth (see the discussion at wikipedia.org under Surcingle).

For use in trailers, the portable battery may be bypassed and the pressure means (pump or compressor) attached to an electrical connection on the vehicle or trailer. Such 12 volt outlets are often provided on horse trailers. The same may be done in stalls equipped with DC power outlets, or with batteries external to the mounted battery assembly. Other options include systems for clinical use in which the equine is constrained and the compressor and electrical source is external the on-board system. For example, an equine can be restrained in a working chute, double tether and the like. It is preferred, for safety reasons, that both the compressor and electric supply (for compressor) be external rather than have the compressor on board. The air supply to the system may suitably be a fixed air compressor arrangement if the use is in a fixed location such as a clinic or stable.

However, the system may be tethered to air support conduits and supplied with pulsing fluid from a stationary system that can be operated on a fixed electrical source or batteries. This reduces mobility but enhanced operating time and allows larger less portable operating system components. Extended cooling is very desirable in treatment of laminitis.

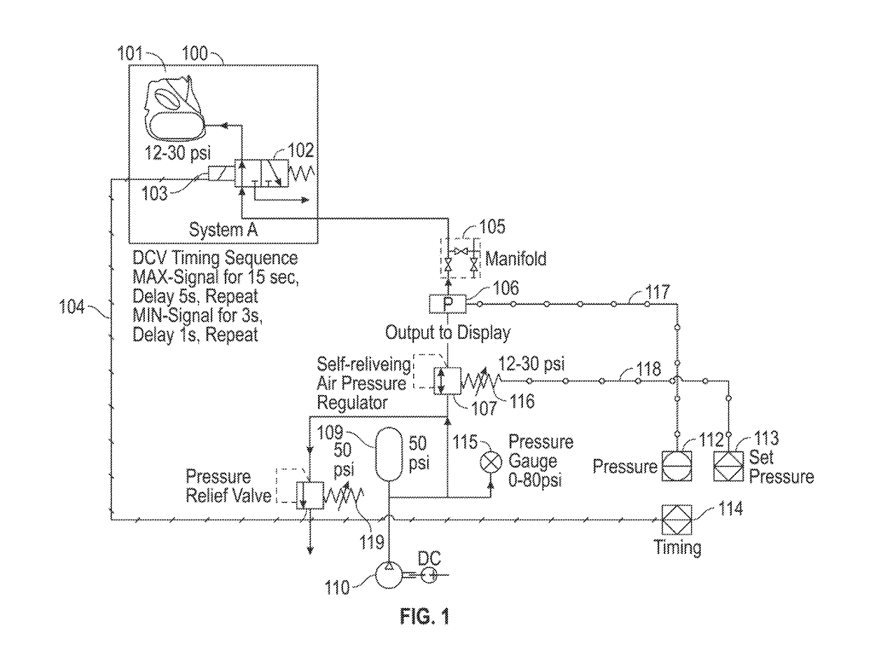

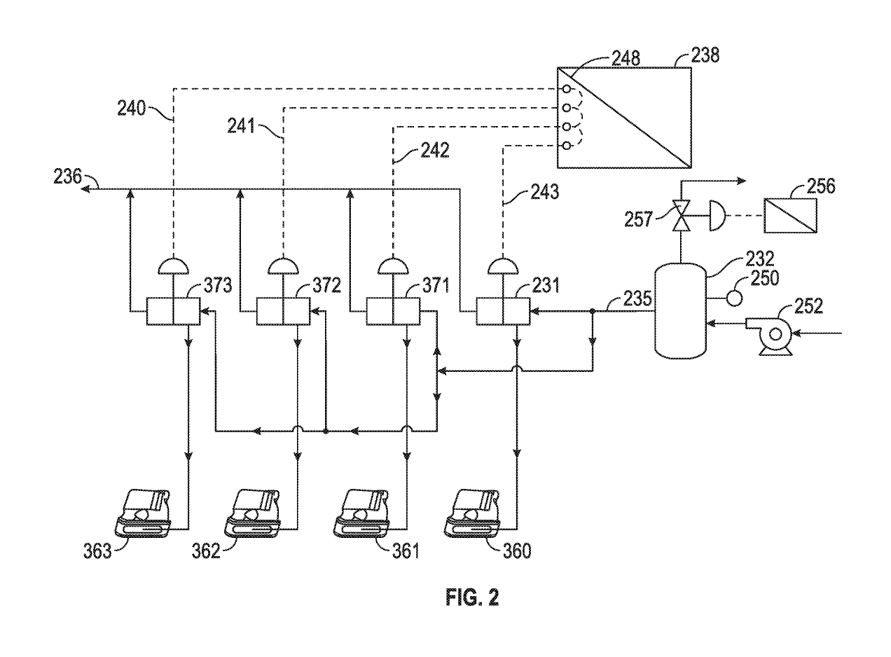

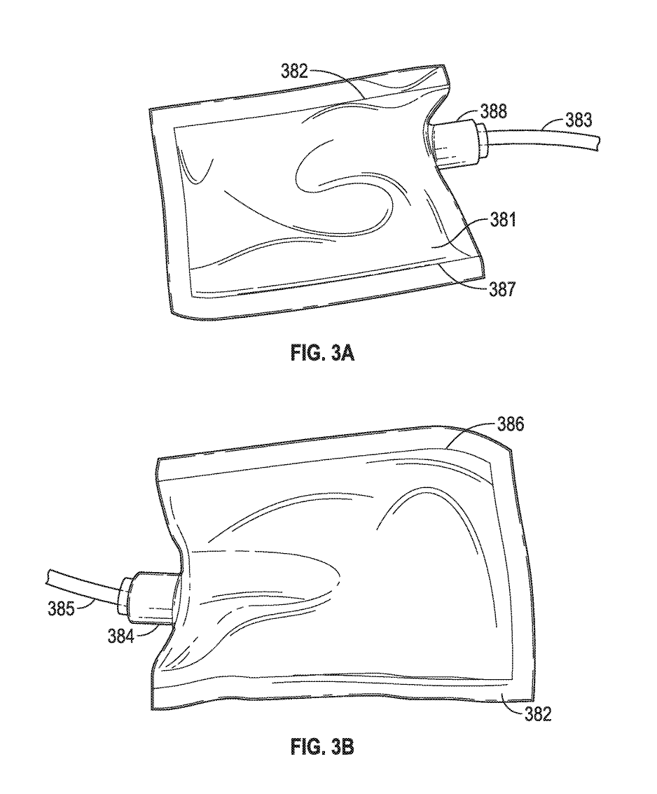

The system can pressurize the boot orthotic pads (bladder) enough to lift the animal off the ground approximately one (1) to one and a half (1½) inches when pressurized. This can be accomplished with an applied pressure in the inflatable bladders of 10-30 psi. In general, the front bladders of a dual pad arrangement will be smaller than the rear pad and will provide less lift—See FIGS. 3A, 3B, 4 and 5. The system can be assembled from easily obtainable and replaceable tubing and valving to connect the boots and the control system. Schematics of the valving and control systems are illustrated in FIGS. 1 and 2 and are explained below.

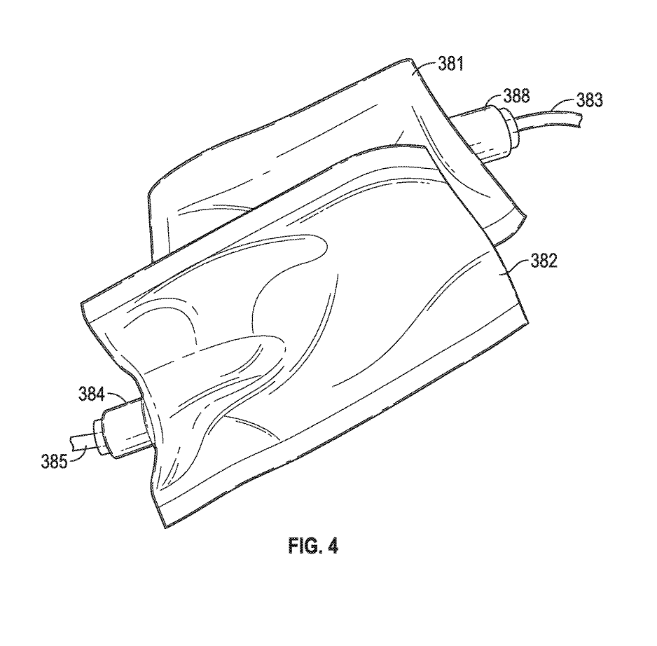

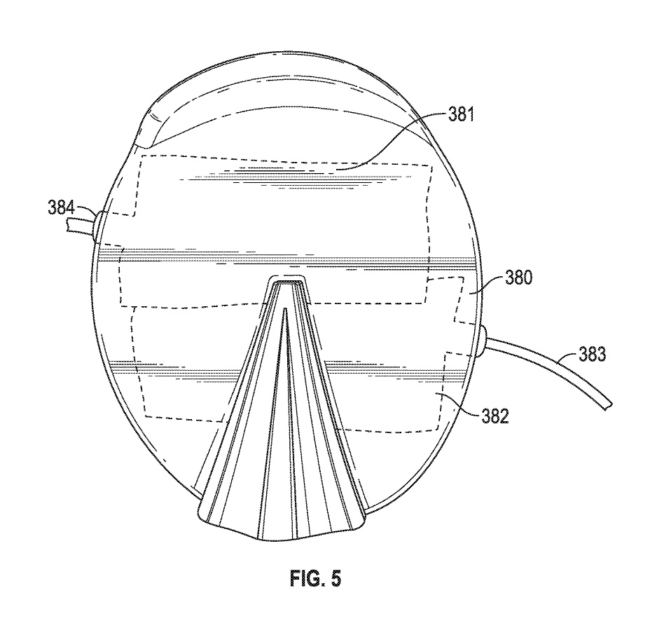

The boot assembly comprises a flexible boot having disposed therein a pad (preferably an elastomeric (gel)), pulsing means for expanding and contracting portions of the pad in a pulsing action to provide a massaging action to the sole bottom and frog of the hoof and optionally disposed in a boot suitable for icing the lower legs. This action cyclically compresses and relieves the frog of the hoof in the same way as does walking or running. The means for expansion and contraction is, in one embodiment, two or more flexible bladders (bags) that may be expanded by pumping into the bag(s) a pressurizing fluid (liquid or gas) and then releasing the pressure so the bags retracts to or substantially near its initial position—providing a cyclical pumping action. Dual bags are preferred. Exemplary pulsing bags or bladders (“pulsers”) are shown in FIGS. 3A and 3B and 4. The bags (bladders) 381 and 382 are sealed 386, 387 and have tubing fitting ports 388 and 384 with a tube for fluid input 383 and 385. The bags may be partially overlapped as shown in FIG. 4 and disposed under an orthotic gel pad (380 in FIG. 5) to raise and lower portions of the pad. The bladders in FIG. 5 are shown under the front and back of the orthotic pad but may be side to side for some special application as in straightening the legs of foals. The pulsing means may also be molded into as an integral part of a pad, where it may be positioned in any segment of the pad, not necessarily the center, thus, allowing pulsing on the portion of the underside of the hoof where most desired (generally the frog and toe). The location and size of the molded pressure pulsing means may be varied to provide the most effective pulsing action, which will vary with the condition of the hoof and desired effect. The desired size and location of the pulses may be controlled by the: 1) placement of the pulsing means in the orthotic pad, 2) hardness (or softness) of the pad material above and around the pulsing means and 3) depth of gel above and below the pulsing means in the orthotic.

In general, the volume of the pulsing bladders will be from about one hundred (100) to about five hundred (500) mL (6-31 cubic inches); therefore, the amount of fluid need not be great, and the pressure system can easily be battery powered and carried by the equine. They may also be of different sizes in the same boot.

The pressure pulsing means (bladders) will have at least one inlet port, 388 and 384 Generally, only one port is required but in some embodiments an inlet and outlet port will be used to circulate fluid, particularly cooling fluid through the pulsing bladder. When air or other gas is the pressurizing fluid chosen, the pulsing means (bladder) can be both pressurized and depressurized through a single port by venting, as through a three-way valve (as illustrated in FIG. 1) or as through a conduit fitted with a pressure relief valve or other pressure relief means.

Pressure levels in the pressure pulsing means need not be excessive—pressures from about 10 to about two hundred seven (207) kPa (0+ to 30 psi) are effective in achieving the desired pulsing action, with pressures from about twenty-one (21) to one hundred thirty-eight (138) kPa (3-20 psi) being preferred. The optimum pressure required for any size and configuration can be easily determined as that needed to raise the hoof of a standing horse the desired amount, generally about 0.5 to 1.5 inches.

In one or more embodiments, the equine boot pad assembly of the present invention can use versions of an equine boot and orthotic pads described in U.S. Pat. No. 7,178,321, issued Feb. 20, 2007, U.S. Pat. No. 7,445,051, issued Nov. 4, 2008, D565256, issued Mar. 25, 2008, U.S. Pat. No. 8,220,231, issued Jul. 17, 2012, U.S. Pat. No. 8,291,683 and U.S. patent application Ser. No. 12/284,925 filed Sep. 24, 2008, all of which are incorporated herein by reference.

### The Boot/Pad Assembly

The basic features of the boot and shock absorbing pad useful in the assembly of this invention are summarized below. The boot/pad assembly comprises a flexible boot (as shown U.S. Pat. No. 8,291,683) and shock absorbing orthotic pad disposed inside and at the bottom of the boot. A version of the pad and boot, as described in the patent and patent applications noted above, is adapted to provide, in some embodiments, dual pulsing means disposed under, or as an integral part of the orthotic pad (as described herein). The term “pulsing” as used herein means the cyclical expansion and deflation of a device or other means to apply cyclical surface pressure against some portion(s) of the underside of the hoof of a horse.

### The Boot

In broad aspect, the boot of some embodiments of the invention comprises an upper portion made from flexible material (as shown in U.S. Pat. No. 8,291,683), shaped to fit the hoof of an animal. See the patents and applications noted above (disclosures of which are incorporated herein by reference). Taller water retaining boots are further described in a separate section below. In general, a suitable boot for the dual or multiple pulser embodiments has a front, sides, rear and bottom; the front slopes back and upward, the sides are lower than the front and rear so that when the front and rear are pulled together there is an opening in the sides. There is a fastening means at the top front and rear to fasten the front and rear together around the leg and hoof of a horse. In one aspect, the bottom is attached to a sole plate base comprising a molded elastomeric structure that is entirely circumscribed by a peripheral wall (or sides) defining a receiving area sized to fit over (or under) the bottom of the upper portion.

The sole plate base is preferably a separate molded piece and is attached to the bottom of the fabric upper. The base helps to hold the boot in position on the hoof and, if walled around the entire circumference, prevents the hoof from sliding forward or rearward while in use. Moreover, the base is important in order to confine the orthotic pad in place and to prevent lateral expansion of the pad. If a relatively “soft” pad is used (as is often desirable), the weight of the horse will flatten the pad and, if there is an opening in the base, as in certain commercial boots, the pad will be extruded out the opening. It is, therefore, especially important that the bottom circumference of the boot sole be sufficiently strong to contain the soft pad when it is squeezed outward by the pressure of the horse's hoof. By having the base wall entirely surround the circumference, the elastomeric pad is held in place and will conform to the shape of the hoof, and will continue to do so as the horse moves. This provides an accommodative surface to allow the horse to find the best natural balance position—similar to the effect of having the horse stand in loose sand.

This accommodative gel surface, combined with the pulsing action described below, provides an exceptionally effective simulated exercise and therapeutic device and method. The ability to achieve natural balance is especially important for horses with injured or diseased hooves. In horses with severe laminitis, the coffin bone (PIII) is pulled downward by the deep digital flexor tendon to such an extent that cutting the tendon (tenotemy) is often prescribed. The deep gel orthotic (pad) of the present invention allows the horse to adjust its stance to relieve this tendon pull, thereby reducing the pain and promoting healing. The deep gel orthotic, combined with the pulsing action, can exercise the tendon, stretching it to the extent that the need for tenotemy is reduced or eliminated. Moreover, tenotemies cause the tendon to re-grow somewhat shorter than it was originally (due to scar tissue, etc.). If a tenotemy is required, the pulsing action of this invention is helpful in stretching and releasing the shortened tendon to promote restoration of the tendon's length and flexibility.

In a preferred embodiment, the bottom of the sole plate base (as illustrated by the cross section of the base) is sloped upward in the front at an angle of about five (5) to thirty (30) degrees from the bottom plane. The slope begins at a point on the bottom of the base twenty (20) to forty (40) percent of the length from front to rear of the base plate. The point of beginning is preferably about one third (⅓) of the distance from the front of the length of the base. This angled sole plate base allows the hoof to rock forward and backward without undue pressure on the hoof. When the horse walks, the boot will naturally “break-over” (i.e. pivot forward), preventing abnormal pressure on the hoof. This rocker effect is well recognized as beneficial, and there are several commercial products—such as the “clog” shoe, and other devices designed to “rock” with the shift in body weight of the horse—allowing the hoof to achieve a “natural balance.” This type of tapered base is more fully described in U.S. Pat. No. 7,445,051, issued Nov. 4, 2008, D565,256, issued Mar. 25, 2008, patent application Ser. No. 12/284,925 filed Sep. 24, 2008, the disclosures and figures of which are incorporated herein by reference. The sole plate base is also suitable for the ice boots described below. An additional “rocker” attachment may also be used and is more fully described below.

The base or sole plate is preferably molded of polymeric elastomer material or hard rubber (having the consistency and hardness approximating that of automobile tires). Thermoplastic polyurethanes (TPUs) are suitable materials for the base plate. It is preferred that thermoplastic polyurethanes of about fifty-five (55) to seventy-five (75) Shore A hardness be used, with Shore A hardness of sixty-five (65) to seventy (70) being especially suitable. Other polymer materials with characteristics like thermoplastic polyurethanes may also be suitable.

### The Pads

The base of the shock absorbing orthotic pad (as shown and described in U.S. Pat. No. 8,291,683 and the other referenced patents and applications noted above) is generally shaped to both approximate the shape of the animal's hoof-print and fit into the boot. This pad, preferably made of shock absorbing material, can be easily trimmed to conform to the hoof of the individual animal on which it will be used. More elongated oval shapes are especially useful in laminitis affected horses, where the hoof is tilted downward because of the abnormal growth rates of the hoof walls caused by the compromised tubules of the laminae. A ridged pad as shown in U.S. D746,519, issued Dec. 29, 2015 the disclosures of which are incorporated herein by reference is especially beneficial. The ridges of this ridged pad allow coolant to circulate beneath the hoof and thereby enhance to cooling effects.

In some embodiments, the pad will not have the triangular projection and/or a front projection that acts as a stop for the hoof even without the frog support, the front bumper projection of the pad is often useful, especially for a horse with a severely injured or damaged hoof. At times, it is necessary to resection (remove the front hard hoof surface) a horse's hoof if it is damaged or diseased. Such is the case with advanced laminitis. In these cases, the soft front support ridge provides extra comfort to the hoof, especially if the pad is wedge-shaped (sloped) in a way that forces the front of the hoof downward.

It is well known that the hoof frog acts somewhat as a blood pump as described in U.S. Pat. No. 4,981,010. With the pulsing means of this invention, the frog will be massaged and flexed, even if the horse is shod and the toe lifted to deduce pressure on injured portion of the hoof. The pulsing action of this invention allows the natural rhythmic application of pressure to the frog to continue even on shod horses. The front pulser means, of dual pulser embodiments, will lift the toe and provide added motion and relief. Dual bladders provide added flexibility to the options for more realistic simulation of walking and for special options for therapeutic applications.

The present invention differs from previous support shoes and or pads that allow the hoof wall to move. An advantage of the relatively large and soft pad (Deep Gel®) is that it enables the horse to adjust the position of its hoof to the most comfortable position. Support of the rear of the hoof reduces the pull of the deep flexor tendon on the coffin bone in tendinitis, and serves to reduce pain and provide support for healing of the lamina.

Likewise, it has been found that the shape of the pad is important. Completely round pads have been found not to perform well in actual use, as they tend to rotate in the boot. An elliptically shaped pad is desirable to maintain consistent fit and to prevent rotation of the pad in use. The shape will depend on the nature of the hooves, for example, Arabian horses generally have more elongated hooves than do Quarter horses. Moreover, more elongated pads are more suited for horses with laminitis, as is discussed above.

To reduce rotation of the pad in the boot 600, it is important that the boot bottom be secured to the top inside surface of the sole plate (to the boot bottom that is attached to the sole plate) and that the pad be secured to the bottom inside of the boot. It is preferred that the attachment of the pad to the boot and the boot to the sole plate be secure but be capable of detachment for removable and replacement. A convenient means of providing a removable, secure attachment is to provide a hook-and-loop strap to the underside of the pad, to mate with a matching hook-and-loop strap on the bottom side of the coolant boot, (672 in FIG. 9). When the mating hook-and-loop straps are connected, it prevents the pad from rotating in the boot during use. The hook-and-loop straps may be sewn to the boot fabric or attached by adhesive. Attachment of a hook and loop strap piece and the appropriate sizes are described U.S. Pat. No. 8,220,231 issued Jul. 17, 2012, the disclosures and figures of which are incorporated herein by reference.

The pads can be made of any suitable elastomeric polymer material that provides flexibility, shock absorbency, some degree of elasticity, resilience, and dimensional stability. Polyvinyl chloride (PVC), polysilicone, and similar elastomers, well known to those in the art, are also suitable. In a preferred embodiment, the base is constructed of a cast polyurethane elastomer. For example, polyurethane casting elastomer having a Shore A hardness of from about ten (10) to about seventy (70) is suitable. It is preferred that the base be of about twenty (20) to seventy (70) Shore A hardness and the support be of about eight (8) to fifty (50) Shore A hardness. In some situations, very soft pads are desirable. These will generally be thicker than harder pads, and will have a Shore 00 hardness of about five (5) to seventy (70).

It is preferred that the material for the pads of this invention have low rebound resiliency, generally lower that twenty-five (25) percent and preferably between two (2) and ten (10) percent. These elastomeric pads are sometimes referred to herein as “gel” or “gel pads” and as “orthotics”.

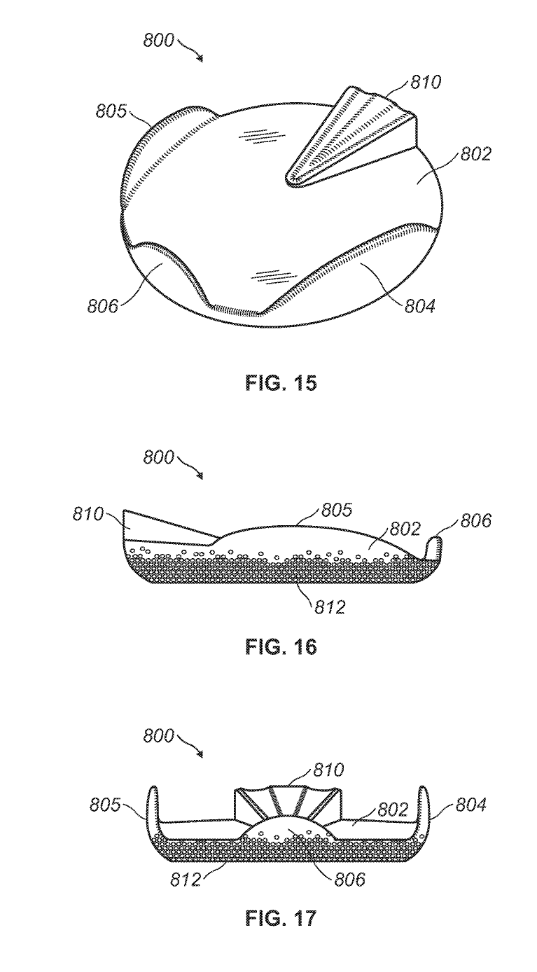

A special toe clip pad as shown in FIGS. 15, 16 and 17, can be especially useful, especially in the more elongated boots described above. The figures show optional dispersion of low density particles in the body of the pad. The separation of the side clips 804, 805 and toe bumper 806 help stabilize the hoof in the boot and being smaller, do not tend to distort as would the pads with a full bumper around the front (as the pads described for pads above). These more elongated pads are also helpful in making the hoof more secure in the boot. If the boot is relatively circular, it may fit well for equine having circular hooves (such as Quarter horses) but fail to properly encircle more elongated hooves. The toe clip pads compensate for this and allow a tighter fit. The separation of the side clips and toe bumper (804, 805 and 806 in FIG. 15-17) is also important as they help stabilize the hoof in the boot and being smaller, do not tend to distort as would the pads with a full front bumper (as the pads described above). The side clips and toe bumper are shorter and thinner than previously described orthotic pads. The pad is also lighter even without the inclusion of lower density particles. The side clips also aid in preventing the hoof from tearing or excessively wearing the boot fabric in the inside front of the boot. A triangular frog support 810 is optional. It aids in pumping blood to the leg as described above, but many farriers prefer to pack the hooves with fillers and do not want the frog support. The term “Toe clip pad” is used herein is the pad illustrated in FIGS. 15-17 with and without dispersed low density particles and as described herein.

This toe clip pad design can be further lightened by dispersing lower density expanded foam particles into the body (not the wings) of the pad as described below. FIGS. 15-17 illustrate the pads with optional dispersion of low density particles, 812, in the body, 802, of the pad as discussed below. The particles, 812 are dispersed in the lower ⅔ of the pad body 802. Preferred beads are expanded polystyrene foam (EPS) beads as they are relatively soft and very light weight. These soft beads reduce the structural stability of the pads and make them somewhat less wear resistant, however, this is not a problem for the pads inside a boots as described herein. The top side of the pad, without the beads take the wear of the hoof. It is preferred that beads not be included in the side clips and bumper. The density of the dispersed particles is desirably in the range of about twenty (10) to five hundred twenty (50) grams/liter (g/l). For example, expanded EPS beads have a density range of about ten to two hundred (10-46) gm/liter, Polyurethane gel elastomer is a preferred elastomer for the pads, having a shore A hardness in the range of eighteen to twenty-two (18-22), has a density of about one thousand twenty-five to one thousand seventy (1025-1070) gm/liter, so the ratio of density of elastomer to that of the dispersed particles will be in the range of from about eight to twenty-eight (22-107). Thus, while the density ratio for EPS in polyurethane gel is smaller it is suitable that the particles be at least half the density of the elastomer and preferably no more than about 30% as dense. These particles also increase the thermal insulative properties of the pad. This insulative property is especially desirable to shield the equine hoof from excessive heat transfer from elevated temperature roadways during transport and hot surfaces of stalls, roadway and arenas where horses must stand for any significant period of time.

Multiple types of particles may be used, differing in composition, size, etc. These different particles may be divided into distinct regions of the pad body 802, or may be mixed together. This may be desirable to achieve certain weight, thermal insulation, durability, support and cushioning properties of the pad.

Another special pad that facilitates coolant flow beneath the hoof is shown in FIG. 14. This pad is also shown in U.S. D746,519 issued Dec. 29, 2015, the disclosure of which is incorporated by reference. The pad, 430, has ridges 432,434 and 433 that will allow water to flow beneath the hoof. The pad has a raised front 438 to provide a comfortable stop for the toe of the hoof. The rear, 436, is generally rounded. This pad is made of the same materials as described above for orthotic pads. It's ridged design facilities the flow of coolant around the hoof. As the horse shifts its weight the ridges compress and expand (but are circumferentially constrained by the walls of the sole plate) to provide a pumping action to move the coolant beneath the hoof and to help prevent stagnant warn spots of coolant. This pad may also be suitably reduced in weight by inclusion of low density beads as described above.

### Mold Process for Manufacture of Preferred Pads

In broad aspect, the method for manufacturing the preferred orthotic pads comprises mixing low density particles (such as beads) with one or more elastomer components during curing to form a molded flexible, shock absorbing pad. In preferred embodiments, the elastomer is polyurethane and the particles are low density, preferably flexible and elastic, thermally insulative, elastic material. The resulting gel orthotic pad is lighter weight and more thermally insulative compared to a pad solely made of polymer material such as polyurethane gel.

In general, the basic process is to mix the elastomer components and catalysts, and to disperse low density particles in the unset elastomer during curing while the elastomer is still substantially in the liquid state. A mold of the desired size and shape is filled with the resulting mixture and the mixture is allowed to set and cure.

In a preferred embodiment, the method comprises mixing the uncured elastomer components with low density particles before curing of the elastomer is complete to form a well-mixed homogeneous suspension. This mixture is poured into an open mold in which the open top of the mold forms the bottom of the boot. The particles will tend to rise to the top of the mold, thus accumulating in the lower portion of the finished pad. Once the elastomer is properly cured, the pad is removed from the mold. The resulting pad is comprised of a layer of elastomer without particles in the upper portion of the pad suitable for exposure to the abrasive horse hoof or shoe, and a layer of elastomer-bound particles in the lower portion of the pad suitable for thermally insulating the hoof from the ground, absorbing shock, and reducing the overall weight of the pad. A middle layer is comprised of an increasing concentration of spheroids dispersed in elastomer as one progresses from the top of the pad towards the bottom.

For the preferred pads that has no particles in the side clips, toe bumpers and frog support, the elastomer components are first poured into the mold to fill just the sections that constitute the mold for the clips, bumper and frog support—these are the lowest part of the mold. When these are partially set, them the elastomer component/particle suspension described above is poured into the mold, resulting in a pad with clips, bumper and frog support free of low density particles and a body of the pad having particles. This procedure is also suitable for the ridged pads to prevent particles in the ridges. It is well within the abilities of one of ordinary skill in the art to select quantities for the variables disclosed above, based on the materials used. Preparation of the elastomer and mixture, preparation of the mold, and pouring and curing of the part are well within the abilities of one of ordinary skill in the art.

In another embodiment, the underside of the pad has a depression to house a pulser bladders. Such pads are shown and described in U.S. Pat. No. 8,166,736, issued May 1, 2012 and U.S. Pat. No. 9,498,638, issued Nov. 22, 2016, the disclosures of which are incorporated herein by reference. The bladder has an inlet port. Inlet and outlet ports could be provided for use if the pressurizing fluid is liquid. The depression in the pad has a minimum depth of approximately six and four-tenths (6.4) mm (0.25 inch) from the surface of the pad, and is generally centered in the pad so as to leave at least about twelve and seven-tenths (12.7) mm (0.5 inch) of pad edge surface space around the depression. This pad edge surface space is to provide support of the equine hoof and may be as wide (from depression to the outside edge of the pad) as thirty-eight (38) mm (1.5 inches), depending upon the size of the pads (to accommodate different size hooves) and the desired support surface for the hoof.

For some purposes it is desirable to have the pulsing means built in as an integral part of a gel orthotic pad. As explained above, placing the pulsing means into the pad provides the most flexibility for size, placement, and location to customize the pulsing means and action.

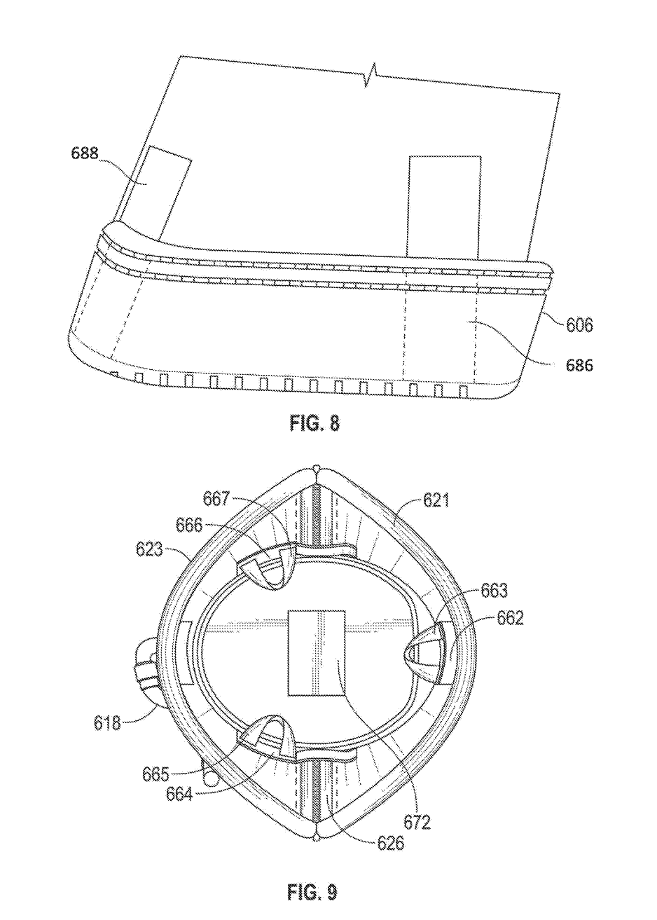

The pad may have a hole in the side for fluid conduit(s) to pass through. Instead of holes, cuts may be made in the side of the pad to accommodate the conduit. Alternatively, the conduit may be extended or connected to longer conduits which are not passed through the side of the boot (see boots in U.S. Pat. No. 7,445,051, issued Nov. 4, 2008, D565256, issued Mar. 25, 2008), but are placed along the inside of the boot (between the boot and hoof) and passed out a side opening or top of the boot to be connected to conduits as shown by in FIG. 8. The pressure pulsing means is sized to fit under the orthotic pad or within the pad's depression and is constructed of a flexible polymer material capable of withstanding the pressure of the weight of a horse's hoof—it needs to be reasonably tough and durable. Elastomeric polymers include Teflon™, Ultra High Molecular Weight (UHMW) polyethylene, some polyurethanes, and the like. The shape and size may be varied to provide optimum fit and function—the design of which is within the capability of those skilled in the art. Choosing a suitably tough polymeric material is well within the skill of one skilled in the art of practicing this invention.

In a test, a pressure bladder, about fifteen (15) by fourteen (14) cm (6 by 5.5 inches), with a single conduit port, was attached to a squeeze bulb with a pressure gage and was placed completely under an orthotic pad such as that described above (without a special depression) and placed on one hoof of a horse. When pressured to about ninety-seven (97) kPa (14 psig), the hoof was lifted about two and one-half (2.5) cm (1 inch). When the horse shifted its weight, the pressure dropped to about fourteen (14) kPa (2 psi). This test demonstrates that high pressures are not needed, and that a pressure in the range of about near zero to about two hundred seven (207) kPa (0+ to 30 psi) is effective to achieve the purposes of this invention.

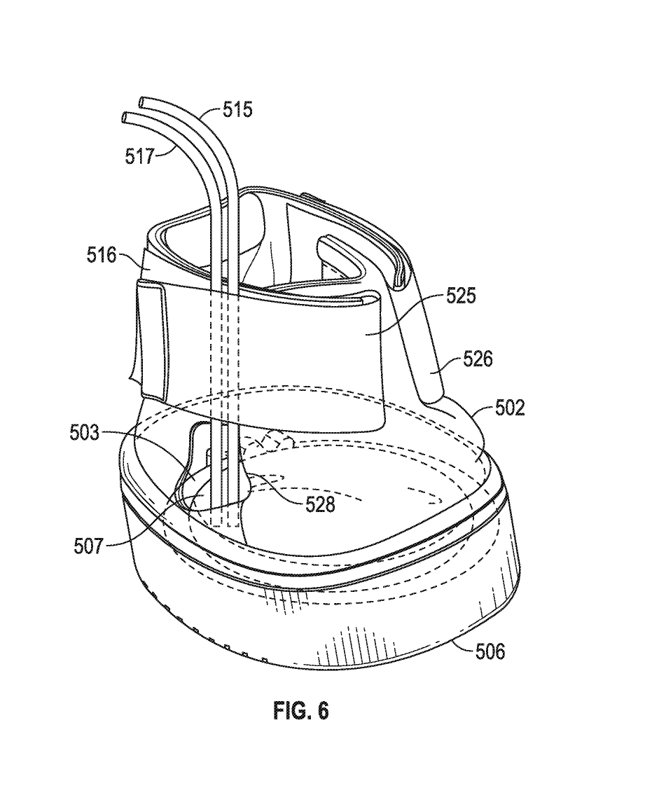

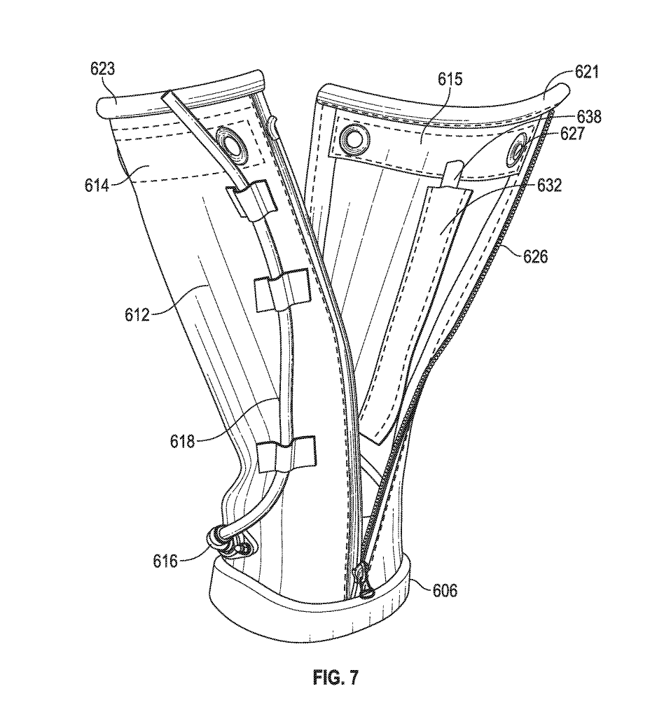

In one embodiment, a conduit is attached to each pulsing means (pressure bladder or bag) and passed through the side of the boot (see FIG. 6). In FIG. 6 there is a boot 502 with a sole plate 506 having side openings 528. The pad 503 is in the bottom of the boot. Conduits 517 and 515 pass through the opening 528 to pulser means placed below the pad 503 in recess 507. Items 516, 525 and 526 are hook and loop straps to hold the boot together on the equine leg. For the taller boots as shown in FIGS. 7 and 10 the lead lines to the pulser will be inserted in the top and down inside to connect to the pulsers. Inserting lead lines through the wall of such boots can be done but would be difficult to seal. For the taller ice boots the conduit is passed down from the top to connect to the pulsing bladders.

In general, to the simplest system of the invention will use air as the pressure fluid (see FIGS. 1 and 2). Air passes to the pulsing means by the e port(s) to pressure the pulsing means. When pressure is released by venting through conduit 236 when the pressurized fluid is closed off, the pulsing means deflates. The pressure is simply vented or directed to pressure another hoof pulsing means.

FIGS. 1 and 2 are schematic views of the valving, compressor and control system of the embodiments of the invention. The figures show regular equine boots but works in the same way for the taller ice boots of FIGS. 7 and 10. In FIG. 2 there is a pressure source 232 with a pressure gage 250 and pump or compressor 252 to maintain constant pressure in the source 232. Valve 257 will release excess pressure. The valve is controlled by controller 256. Pressured air, gas or liquid is passed to three-way control valves 231, 371, 372 and 373. The controller 238 controls the valves in a fixed or adjustable sequence to simulate the desired gait of a horse. Pressure fluid passes to boot bladders 360, 361, 362 and 363 to inflate and deflate the bladders. The fluid may be vented via conduit 236 or, alternatively, may be recycled to the pressure source, as through the inlet to pump 252. Also, if the bladders have two ports (as described above) the fluid may be returned from the bladder to the pressure source. In one embodiment, the pressure fluid will be coolant that is maintained at a low temperature. A coolant fluid will be circulated through the bladder, and perhaps cooling tubes around the legs to lower the blood temperature. Details of such a hoof and leg cooling system are described in patent application Ser. No. 12/581,620, filed Oct. 19, 2009, Publication No. US 2010-0095641, the description of which is incorporated here by reference.

FIG. 1 illustrates a valve and control system of embodiments of the invention. System 100 is the boot, 101 and valve assembly comprising the valve system 102 and 103. Item 104 is a signal line from timer 114 to 103 to control the valves 102. 105 is a manifold for directing fluid flow. 117 and 118 are signal lines. Item 113 is means to set the pressure and 112 is a pressure gage as is 115. 109 is a pressure reservoir and 110 a fluid pump. 107, 119 and 116 is a control valve assembly. This arrangement allows very simple adaptation of a “standard” Soft-Ride® boot assembly (boot assembly described in U.S. Pat. No. 7,445,051, issued Nov. 4, 2008 and D565256, issued Mar. 25, 2008 and U.S. Pat. No. 8,291,683) and easily adapted for ice boots described herein. The pulsing means are placed under or in the gel orthotic pad, or the gel orthotic pad is replaced with an orthotic with integral pulsing means, and the conduit is then passed out the side opening of the boot or up the inside wall. Thus, purchase of a special boot is not required.

In another embodiment, illustrated in U.S. Publication No. 2011/0067366 and U.S. Pat. No. 8,291,683 (the disclosures of which is incorporated herein by reference) the base or bottom of the sole plate is fitted with a “rocker” attachment to provide more flexibility in breaker range and position. A complete description of rocker attachments suitable for this invention is described in patent application Ser. No. 12/882,352, filed Sep. 15, 2010, U.S. Publication No. 2011/0067366 A1 and U.S. Pat. No. 8,291,683, the disclosures, teachings and Figures of which are incorporated herein by reference. “Rocker Attachment” as the term is used herein means the attachment described and those described in application Ser. No. 12/882,352, U.S. Publication No. 2011/0067366 A1 and U.S. Pat. No. 8,291,683 and those obvious variations as will be evident to those skilled in the art.

### Operation of the Walker Simulator of the Invention

In operation, boots are fitted with a pad (FIG. 5), having a pressure pulsing means placed under or integral with the pads as illustrate in FIGS. 1-2 and placed on the equine. FIG. 2 shows a conduit 235 connected to the pulsing means and running from a pressure source or tank 232. A three-way valve 231 is controlled by controller 238, which directs the pressurizing fluid into the pressure pulsing means 360 or out of the system by conduit 236. Each boot will have two pulsing means. If the fluid is air or other gas, it may be simply vented into the air or directed to another hoof pulsing means. If it is a recoverable fluid, it may be directed to a storage vessel to be transferred back into pressure vessel 232.

The controller, 238, allows pressurizing fluid into pressure pulsing means 306 through control valve 231 to inflate the pulsing means. To deflate, the controller closes the pad conduit side of the valve and opens the vent 236 side, thus, allowing the pad to deflate. The inflation and deflation of pressure pulsing means 306 provides a pulsing action on the bottom of the hoof similar to walking or running. Dual pulsers provide even more realistic action and the allow option on motion for treatment protocols. Pressuring and release is automated, as shown in FIGS. 1 and 2 by a suitable control means, 238. Such control will ideally allow the timing and sequence of the pulsing to be easily adjusted. The controller 238 optionally, has suitable indicators to indicate the position of the control valves. Indicators may be lights or alarms, preferable LED lights. A pressure reservoir will suitably have a pressure gage 250 and means to maintain pressure, such as a compressor or pump to maintain pressure in pressure source 232. If the pressure means is a pump that is directly connected to conduit 235 the reservoir 232 may be an open vessel to hold the liquid fluid.

In one configuration, the pulsing action is provided for all four hooves and is coordinated between the hooves; thus, on the front hooves, one hoof pulsing means is inflated in sequence in each boot while the other hoof pressure pulsing means is deflated, then the action is switched. The pressurizing arrangement is duplicated for each hoof boot or is modified with multiple inlet and outlet valves as detailed above. The arrangement allows variation in pressure (lift) and timing intervals. Pulsation of the rear hooves can be similarly coordinated with each other and with pulsation of the front hooves, in order to simulate the rhythmic pattern of equine gaits, such as walking, trotting or running. Pressurization fluid passes through conduit 235 to each of the three-way valves: 373, 372, 371, and 231. When deflated, the air is vented through conduit 236 or recycled as explained above. These valves are controlled by signals from controller 238 through signal leads 240, 241, 242, and 243. Items 248 are optional signal lights (e.g. LEDs) to indicate activity. In one embodiment, the pressure in tank 232 is controlled by controller 256 and pump 252. Controller 256 activates pump 252 to add pressure, or opens a valve to release pressure. Tank 232 also has optional pressure gage 250. A pulsing sequence for each boot of about 0.5 to 6 seconds will approximate walking, with a sequence of about 1 to 3 seconds being preferred. Generally, at a walk, three hooves will be on the ground and one off the ground, as explained below. In that case, three hoof bladder pair will be inflated in sequence while one will be deflated, and inflation and deflation will be appropriately sequenced. For example, the bladder in boot 360 may be deflated, simulating boot 360 off the ground, and boots 361, 362, and 363 will be inflated, simulating contact with the ground.

The pulsing sequence, timing, and degree of inflation can be customized by the user to find an optimum, and can be varied to adjust the routine to obtain additional benefits. The timing to simulate any condition of walking, or other gaits, can be easily discerned and the operation of the pulsing boot assemblies (pulse timing, hoof sequencing, etc.) set to obtain appropriate simulation of these natural gait conditions. A walking gait is preferred. For example, it is known that “The walk is a four-beat gait that averages about 4 miles per hour (6.4 km/h). When walking, a horse's legs follow this sequence: left hind leg left front leg, right hind leg, right front leg, in a regular 1-2-3-4 beat. At the walk, the horse will always have one foot raised and the other three feet on the ground, save for a moment when weight is being transferred from one foot to another.” See en.wikipedia.org/wiki/Horse gaits. Thus, at a walk, three of the hoof pads will be inflated, simulating hooves on the ground, and one will be deflated, simulating the hoof that is raised. Then the deflated hoof pad will be inflated, simulating the hoof being placed on the ground and another hoof pad will be deflated, in the sequence described above. For gaits other than a walk, the timing, sequence, number of hooves on the ground, and pressure applied may vary. This can easily be simulated by reference to the description of the gaits as in the reference above. Timing of the pulse will be longer if simulating a walk than it will be for faster gaits and the sequence will be different.

### Ice Spa Pulser Embodiments

The above described systems show the dual pulsing system disposed in an equine boot as described. In another set of embodiments, the pulsing system is disposed in a taller water retaining boot structure that may be filled with coolant fluid (water is preferred) and ice to provide cryotherapy. Sea salt and/or magnesium salts may also be added to water and means to bubble air through the fluid to provide a kind of ice spa. These boots are termed herein as “ice spas” or “ice boots”.

A very suitable boot for this ice boots is described in detail in U.S. patent application Ser. No. 14/465,006 filed Aug. 21, 2014 now U.S. Pat. No. 9,055,732, the disclosures of which are incorporated herein by reference. Another suitable boot is similar, but does not have zippers. Two sizes of the boots are appropriate—one that is tall enough to cover the equine knees and lower boots. Such boots can be insulated with a kind of insulative blanket placed around the outside of the boot.

The boot has sides and bottom of water retaining fabric, a sole plate that is semi-rigid and has a solid bottom and side walls extending entirely around the circumference of a sole plate, means to removably secure an elastomeric pad to the inside bottom of the boot and means to inject air into the lower section of the reservoir. Optionally the boot has at least one zipper and/or at least one batten pocket extending from the top of the boot downward. Boots without zippers or other opening that extend above the ankle are also suitable. The boot and equine leg may be removably connected by a collar attached around the leg. This collar may be as described below and illustrated in FIGS. 8-9 and 11-13. In another embodiment, there is a collar that fits around the leg above the knee with straps that adjustably attach to the top section of the boot sides. This is very suitable for boots without side zippers.

In use, the boot is partially filled with water and crushed ice and, optionally, air is circulated into a port at the lower end of the boot or directly into the boot from the top through a suitable conduit. In some embodiments, sea salt is added to the water in the boot optionally together with magnesium salt such as Epson salt. Sea salts contain many elements other than sodium chloride that are beneficial in spa treatment including potassium, calcium chloride and bromides. Sea salts with varying amounts of other compounds are available commercially. Magnesium salts that are soluble in water are also available. Magnesium sulfate and magnesium chloride are useful. In general, it is desirable that the salt concentration be about twice that of sea water. A concentration of about 0.2 pounds of sea salt and 0.3 pounds of magnesium salt has been shown to be effective. Since the effectiveness of the osmotic effect of the minerals is determined by concentration (and temperature) optimum salt levels may be determined by simple experimentation. The salts may be prepackaged in the correct amount to add to a predetermined amount of water in the boot reservoir. Coolant temperatures of about 32-40° F. are desirable. Treatments (legs in coolant) of about 20-40 minutes have been found effective.

Temperatures were measured in a test of a prototype ice boot holding about 2.5 gallons of water and ice (about 1.75 gallons of liquid water) with 5 ounces of Epson salt (magnesium) and 3 ounces of sea salt. Temperature of the water after about 20 minutes was 27° F. The hoof was about 32° F. A control hoof that was not in a boot was 65° F.

In some embodiments the boot is made of semi-rigid material. Embodiments of the invention with a boot reservoir are illustrated in FIGS. 7 and 10. The boot may be made of a simple water-proof fabric and in some embodiments has at least one zipper, and preferably two, to facilitate placing an equine leg in the boot. The boots, in preferred embodiments, have a drain, 616, with a plastic conduit, 618, attached that can also be used (if transparent) as a sight glass for liquid level in the boot and as a conduit to carry air (or other suitable gas) into the boot to provide circulation and a bubbler effect and to increase oxygen content of the coolant liquid. The boot will in some embodiments also have a harness to attach to the equine leg and to securing means in the boot to prevent the equine from stepping out of the boot, i.e. to allow the boot to be lifted with the leg.

Referring to FIG. 7 there is shown a coolant boot assembly having a coolant boot 601 disposed in a sole plate 606. Preferably the sole plate walls are sewn (or attached by adhesive or both) to the sides of the lower portion of the boot. Suitable and effective sole plates are illustrated in the Figures and, as with the coolant bag embodiments described above, are described in more detail in U.S. Pat. No. 8,220,231 issued Jul. 17, 2012 Similar suitable sole plates are described and shown in; U.S. 2011/0067366 published Mar. 24, 2011; U.S. D565,256 issued Mar. 25, 2008 and U.S. D616,614 issued May 25, 2010. The descriptions and Figures of these applications and patents are incorporated herein by reference for all purposes.

The boot is open at the top. The boot may also have a drain, 616 in FIG. 7, to enable coolant to be drained off. Drain valves such as those used to drain boats that have a plug that is retained in the drain hole are very suitable. Water is drained through a flexible (preferably transparent) drain tube (616 in FIG. 7). The tube can be loosely attached to the sides of the boot as shown FIG. 7. The tube may also be attached to a suction bulb to initiate a siphoning action to drain water from the boot. Additionally, the tube may be attached to a pump to circulate water in the boot and around the equine hoof or an air pump to bubble air through the water in the boot. A ridged pad (FIG. 14) discussed above facilitates circulation beneath the hoof. Coolant may also be circulated into and out of the boot by suitable pumping means through the tube or through conduits that are placed along the inside wall and extending to near the bottom to outside the top of the boot at the top of the boot. The tube, 618, when attached to the drain 616 and disposed alongside the boot as shown in FIG. 7 can be used as a handy sight glass, if transparent or translucent, to determine the liquid level in the boot. The tube can also be used to bubble air or other gas into the liquid in the boot to mix the coolant, oxygenate the coolant and provide a massaging action. This may be particularly useful in the ice spa embodiment described below. Pulsing means air supply lines may be run down the inside wall to the pulsing mans or may be attached through fitting like those of the drain 616 in FIG. 7.

Referring to FIG. 7, a prototype boot is conical shaped for better mobility and to provide less torque on weakened lamini. The conical shape facilitates icing of the hock joint without the need for the boot to be enlarged over its entire length. The conical shape also enables it to be conveniently used on both front and hind legs and high enough to include the knees and hocks with the taller model. This is important for the taller boots that are designed for performance horse treatment. The shorter version is better suited for treatment of laminitic horses a where the hock joint does not need icing. The shorter boot can have a smaller top circumference that will be lighter and allow (with an optional top closure) horse to better ambulate and to lay down. This is very desirable longer treatment protocol such as in a three day, 72 hour, treatment protocol because the lamini is painful and inflammation is weakened the connectivity of the hoof wall and bone column.

In boots with zippers, waterproof zippers, 626 are located around the sides, 612, of the boot 601. Two zippers placed opposite each other have performed well in trials of a prototype and are preferred. One or more zippers are suitable in appropriate circumstances. These zippers allow the boot walls, 612, to be opened to allow the equine hoof to be fitted into and secured in the boot and be properly placed on an orthotic pad, located in the inside bottom of the boot. Items 632 (FIG. 7) are pockets extending substantially the length of the boot wall into which are placed stiff battens to hold the boot upright and prevent sagging. The battens, 638, can be removed to fold the boot dawn or spread the sides as in FIG. 7. In a prototype, the walls, 612, were made of a Polyurethane (TPU) coated fabric and the batten polymer pockets and zipper were rf welded to the TPU fabric. The relative locations of the zippers (610) and batten pockets, 632, are shown in the Figure. These locations are illustrative only and have proved useful in a prototype, but other locations, and number of zippers and batten pockets may also be varied as desired and such other arrangements are within the scope of this invention. The important aspect is that the boot walls may be opened (or able to be folded down) to fit the hoof into the boot and secure it to the boot bottom. The removable battens hold the boot upright in use but can be removed when the sides are opened or rolled down. Other forms of opening devices, rather than zippers that will allow the boot to hold water for a substantial period are also within the scope of the invention. Lighter weight fabric may be used to allow a boot without zippers or other side opening to be rolled down to allow access to the boot bottom. Items 627 are optional grommets that will allow the boot to be suspended from a strap or harness on an equine back (or otherwise) and are useful but not an essential component of the invention. Reinforcing fabric, 614 and 615, is used to strengthen the grommet area. The top of the boot has a fold of fabric, 621 and 623 that provides a smooth top side and may be filled with foam such as a foam rope to help prevent the boot top from cutting the equine leg. The fold is made of polymer fabric that can provide a soft, smooth surface to prevent chafing or otherwise damaging the skin of the leg.

Air is circulated in the boot by attaching an air pump to the conduit 618. As described for the other embodiments, an air pump such as those available for hydroponics, weighing about 4-8 pounds works well. The air pump can be battery operated and fitted with a connection for an external 12 volt power source. In one aspect, the air pump will have eight outlets to accommodate pulsers on all four hooves.

Prototype boots were made with a top circumference of about 34-36 inches and a height of about 26 inches for boots for treatment of exercise stress (as with performance horses) where it is important that the knees be covered. Boots for laminitis treatment can generally be shorter and have a bottom of about 22 inches with a top circumference of about 28 inches. These dimensions are illustrative only and may vary as desired.

FIG. 10 illustrates a prototype of a boot of this invention fitted on a horse's, 650, leg. The leg 651 is fitted into the boot 600. The top collars 623 and 621 help protect the leg from rubbing injury.

The boot may be constructed of any suitable material, such as fabrics and flexible polymer materials capable of retaining water. Since it is desirable that there be means for attaching the cooling boot to an orthotic pad on the top side of the bottom of the boot and to the sole plate on the bottom side of the boot, the material should be one that will allow such attachment. Fabrics, such as those used in other equine boots may be used and may to be coated to make them waterproof. A TPU coated polyester fabric is used effectively in prototype boots. In a prototype, a TPU coated fabric (for example polyester or polyester or Nylon™) is used to good effect. The fabric is commercially available from numerous sources including Mesa Laminated Fabrics (see information at mesafabrics.com) and Eastex Products. In a prototype, Mesathane 6036 from Mesa Laminated Fabrics (35 or 45 gage) works very well. The TPU coating allows RF welding that is an important consideration in constructing batten pockets and attaching zippers described below.

Coolant may be as simple as crushed ice in water, which in the open top boot will be very suitable and is preferred. Other coolants may also be used, particularly if the coolant is externally cooled and circulated in the boot. Suitable coolants should have good thermal conductivity, a low flash (or vaporization temperature) point, be non-corrosive, inexpensive and readily available and be able to dissolve sea salt. Some useful coolants include, but are not limited to: water, ethylene glycol, propylene glycol, methanol/water, ethanol/water, calcium chloride solution, potassium formate/acetate solution. The choice of coolant can also be made to affect the temperature of the coolant. Generally, coolants will be above about 32° F.

### Removable Attachment, Harness, of Equine Leg to Boot

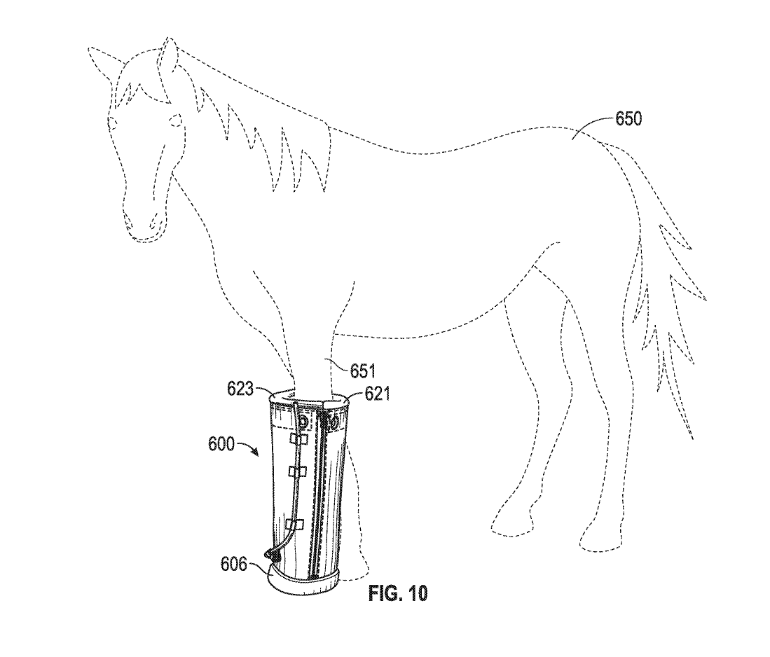

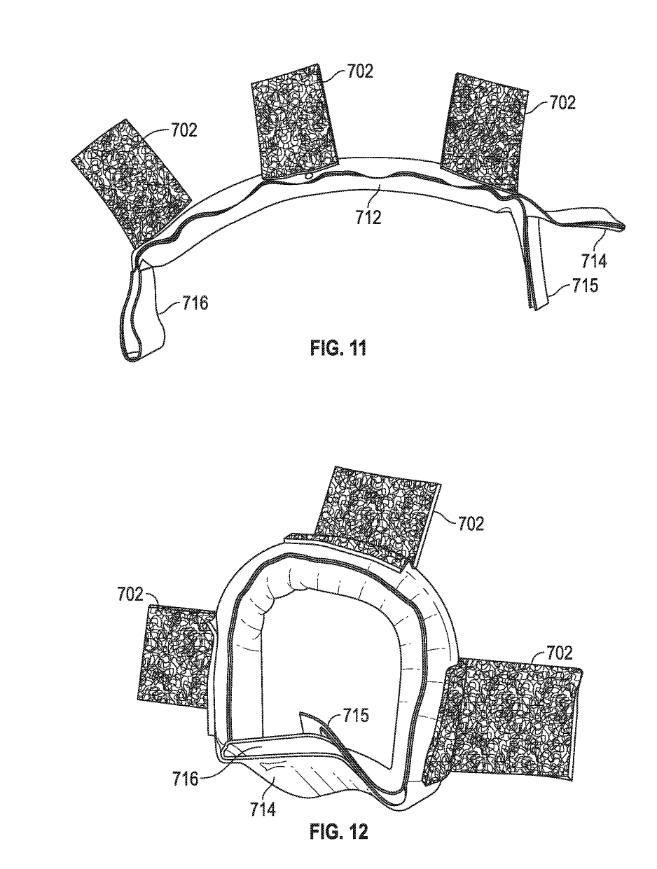

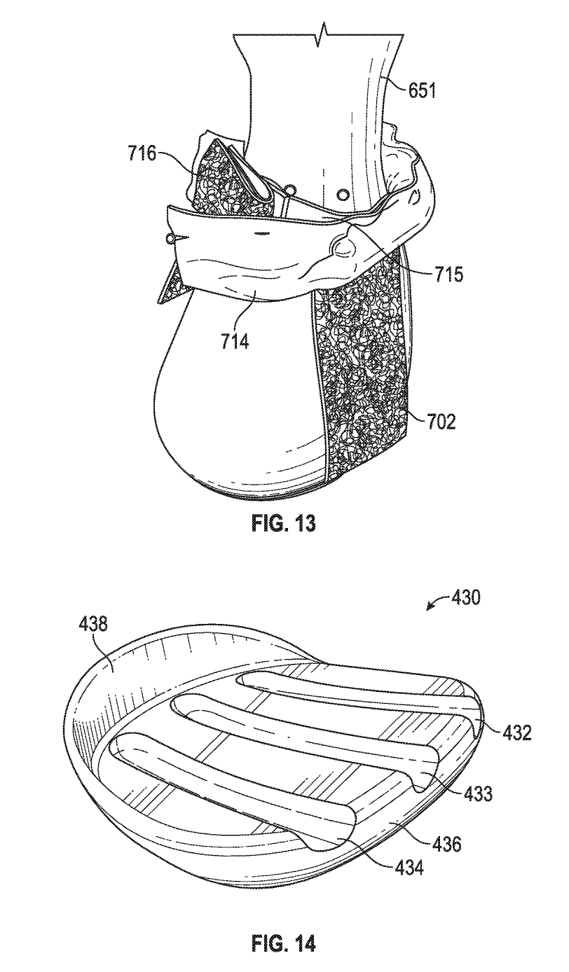

An important aspect of the ice boot and ice spa embodiments of this invention is the inclusion of means to removably secure the equine leg and hoof to the boot so that when the equine lifts its leg the boot will remain attached. A preferred attachment means is shown in FIGS. 11-13. Referring to FIGS. 11-13, there is as soft fabric member 712 to which is attached three hook and loop straps 702. Straps 714,715 and 716 are designed to hold the collar into a circle around an equine leg, 651 (FIG. 13) and straps 702 attach to matching straps in a boot bottom, 686 and 688 in FIG. 8. This collar will generally be a fold of fabric sewn together and may have a foam rope inside to aid in attachment around the leg and in preventing chafing and other damage to the skin of the leg. The collar is attached around the leg with hook and loop straps 714,715 and 716. The relative location of an embodiment is as shown (at positions 2, 6 and 10 o'clock, based on clock face). The collar, 712 of FIGS. 11 and 12 is placed around the equine leg, 651, as illustrated in FIG. 10. The collar is attached to the leg and the leg and hoof placed in position in the boot bottom and the hook and loop straps of the collar (712) are attached to the straps 662, 664 and 666 in the boot bottom. There are optionally provided tabs 663,665 and 667 (FIG. 9) to facilitate alignment and proper attachment of the loops. The items 662, 664 and 666 are hook and loop mating straps so one will be a hook strap and the other a loop. This provides a removable attachment of the leg to the boot so that when the equine lifts its leg the boot will stay connected to the hoof and remain in proper position on the orthotic pad. This also helps prevent getting ice particles under the hoof that could cause discomfort when the equine stands down.

A preferred fabric for the collar is a custom woven anti-rub cover of UHMW (ultra-high molecular weight polyethylene). The fibers have a very low coefficient of friction, significantly lower than nylon and are comparable to Teflon and are highly resistant to abrasion and have extremely low moisture absorption.

As discussed above, for boots without side openings (such as zippers) it is preferred to connect the boot top the leg with a fabric collar that fits around the leg above the knee that has straps that attach to the sides of the top section of the boot.

An additional optional aspect of the coolant boot assembly of the invention is a flexible removable closure for the top of the boot. If the boot is placed on a horse and the horse is jostled or lies down the iced water will spill out of the boot. A suitable top closure is made of neoprene closed cell foam material and is described in U.S. application Ser. No. 14/465,006, filed Aug. 21, 2014, now U.S. Pat. No. 9,055,732, the disclosure of which is incorporated herein by reference. In a preferred embodiment, there are two matching pieces that are attached by hook and loop straps to the hook and loop straps in the top circumference of the boot. On one side, there is a half of a hook and loop strap system. On the other side, there is also a half of a hook and loop strap system. The pieces are attached to the boot top straps by mating the hook and loop straps on the top closure pieces to those on the top inside of the boot. The pieces can then be wrapped around the leg of an equine and secured by mating the straps. Suitable flexible materials will be apparent to those skilled in the art. An ⅛-inch-thick closed cell polyurethane foam fabric is used in a prototype and works well.

### Ice Boot Orthotic Pads

Suitable shock-absorbing orthotic pads for these ice boot and spa embodiments are the same as described for the boot embodiments described above including those described and illustrated in U.S. Pat. No. 7,445,051, issued Nov. 4, 2008, U.S. Pat. No. 8,220,231, issued Jul. 17, 2012, U.S. D616,614 issued Jul. 22, 2014 and U.S. application Ser. No. 29/454,564 filed Mar. 10, 2013, the descriptions and Figures of which is incorporated herein by reference for all purposes. The pad may or may not be sloping towards the front.

### Ridged Orthotic Pad

The boot apparatus and method can be used on shod and unshod horses. It will be an advantage in some circumstances to have the hoof shod, all things being equal, since the shoe will allow coolant to contact the sole of the hoof as well as the wall. Plastic or polymer, light weight shoes that can be attached to the hoof without nails (as with an adhesive) are preferred. As discussed above the dual pad pulsing means (pad and pulser bladders) are disposed in the ice boot. Alternatively, the whole boot assembly as described in the first set of embodiments may be placed in the ice boot/spa. In operation, the pulsing means will be operated in the same manner as the pulsing means in a fabric boot.

### Fitting the Ice Boot on an Equine Leg

In a boot with zipper(s) or other openings as in FIG. 7, the sides are open and laid back. The leg is guided into the boot and if the harness (FIGS. 11-13) is used the leg will have the harness attached. The hook and loop straps on the harness (702 in FIGS. 12 and 13) will be attached to the straps in the boot bottom (662, 664 and 666 of FIG. 9) and adjusted and the openings closed. Similarly, if there is no zippered opening in the sides of the boot its walls may be rolled down and the harness connected as described above.

The boot assembly as described in the embodiments above is fitted with an air pump (battery or power operated) to inject air through the tube 618 and drain 616 into liquid in the boot. The boot is partially filled with water and crushed ice and the air circulated. Sea salt may be added to the coolant in the reservoir and optionally magnesium salt. Sea salts contain a number of elements other than sodium chloride that are beneficial in the spa treatment including potassium, calcium chloride and bromides. Moreover, the source of sea salt is important in selection of trace minerals. For example, it is reported that waters from the Dead Sea are unique in that they contain 27% of various salts as compared to 3% in normal sea water. Further, while sodium accounts for approximately 80% of the salt content of normal sea water, it comprises much less of the salt total in water from the Dead Sea. The balance of the salts in Dead Sea water is magnesium, potassium, calcium chloride and bromides. Sea salts from various sources and with varying amounts of minerals are available commercially. Magnesium salts that are soluble in water are also available. Magnesium sulfate and magnesium chloride are useful. As with sea salts magnesium salts from different natural sources are available.

In general it is desirable that the salt concentration be about twice that of sea water. A concentration of about 0.2 pounds of sea salt and 0.3 pounds of magnesium salt has been shown to be effective. Since the effectiveness of the osmotic effect of the minerals is determined by concentration (and temperature) optimum salt levels may be determined by simple experimentation. It is reported that concentrations of 2 and 7.5% sea salt in water were very effective in reducing pain and increasing mobility in human trials. Machtey, Dr. I. 1982, Dead Sea Balneotherapy in Osteoarthritis, Proc. International Seminar on Treatment of Rheumatic Diseases. It is assumed that the same is true of equine legs. The salts may be prepackaged in the correct amount to add to a predetermined amount of water in the boot reservoir. Coolant temperatures of about 32-40° F. are desirable. Treatments (legs in coolant) of about 20-40 minutes have been found effective. A short prototype of the boot assembly will contain about 2.25 gallons of coolant with an equine leg in the boot. A taller prototype holds about five (5) gallons.

A suitable method of filling the boot is to fill the bottom of the boot to above the ankle (about one gallon in the prototypes) add salt then add water and ice to fill the boot. Adding water first keeps the ice from lodging under the hooves (it floats) and allows good mixing of the salts.

### Method

The method of the invention comprises fitting a horse needing cryotherapy treatment and/or suffering from or in danger of the onset of laminitis on one or more hooves with cooling boot assembly described herein, filling the cooling boot with coolant (and replenishing the coolant as it gains temperature) and minerals for sufficient time to and temperature to effect measurable cooling of the leg and hoof, and injecting a gas into the coolant. The minerals that are beneficial are sea salt and, optionally, magnesium compounds in effective amounts as described above.

Based on a study by Dr. Andrew W. van Eps, horses can withstand prolonged near freezing cold application. “When cooling the feet, the length of application time varies from case to case. “When used in a sick horse for preventing laminitis, it may be applied for 3 to 7 days. In a horse that has just developed laminitis, 2 to 3 days of continuous cryotherapy may be used, provided it's not used in cases where there is infection in the foot, such as occurs with many chronically laminitic horses with concurrent foot abscesses. “He adds that while those temperatures and time frames would be highly dangerous to humans, the horses seem to tolerate them quite well. “I think they're somewhat adapted, as a species, to walking around in snow and cold weather,” he says. “In the horse, we can cool the foot to 41 degrees using ice water for several days without apparent adverse effects, while those same temperatures are painful for us and can actually damage our tissue.” From the article by Lisa Kemp, Stopping Laminitis Cold; American Farriers Journal, September/October 2011; www.americanfarriers.com. This paper provides guidance for the application of cooling in this invention and its teachings are incorporated herein by reference.

### Special Applications

The simulated walker embodiments described herein can be especially effective in special situations in addition to the purposes above described. For example, in human knee surgical recovery is enhanced by exercise such as with a knee machine. The same effects can be achieved for equine surgery recovery by use of embodiments of this invention. The leg of a recovering animal can be placed in the boot and the sole pulsed periodically in a controlled way to provide the right kind of simulated exercise to optimize recovery.

Additionally, many equine foals are born with crooked legs. Since in the first early days the bones are soft and malleable it is conventional therapy to place shoe pads on the sides of the hoof to turn the leg to have it grow straight. The systems of this invention with the pulsers placed on the sides, as opposed to front and back, can be used in a much more controlled way to aid in the straightening foal's legs. The toe clip orthotic pads will also facilitate the treatment.

In the foregoing specification, the invention has been described with reference to specific embodiments thereof. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

1. An equine boot assembly comprising:
a boot comprising a reservoir made of a flexible material for containing coolant having side walls, a closed inside bottom, an open top, an underside with a top and bottom, the underside bottom having a sole plate with a bottom, inside top side and side walls into which the closed inside bottom of the reservoir is disposed and attachment means to attach the underside of the reservoir to the inside top side of the sole plate;
a removable elastomeric shock absorbing pad disposed inside the boot in the bottom of the reservoir on top of a layer of reservoir material, and
pressure pulsing means disposed under or within the shock absorbing pad.

2. The boot assembly of claim 1 wherein the underside of the reservoir has a wall extending upward around its entire circumference attached to the side walls and the pressure pulsing means is two or more inflatable bladders adapted to allow fluid is to be injected and released to cause the bladders to inflate and deflate the bladder or bladders.

3. The boot assembly of claim 1 comprising at least one zipper in a side wall of the reservoir.

4. The boot assembly of claim 1 wherein the removable elastomeric shock absorbing pad has a top, side, bottom, top front and top rear and is ridged on the top side or is a shock absorbing pad having a front bumper projection on the top front and separate side clip projections on the top sides.

5. The boot assembly of claim 1 wherein the removable elastomeric shock absorbing pad has lower density particles disposed in the pad to reduce weight.

6. The boot assembly of claim 5 wherein the lower density particles are expanded polystyrene foam and the elastimeric pad is mad of polyurethane gel.

7. The boot assembly of claim 1 wherein the sole plate is fitted with a rocker attachment.

8. The boot assembly of claim 1 having means to removably connect the boot to an equine leg, said means comprising a fabric collar that is designed to removably and adjustably surround an equine leg above the coronet bone of the leg and that has hook and loop straps attached and positioned to allow the straps to be connected to matching hook and loop straps attached to the inside bottom of the boot to enable the fabric collar to be attached to the equine leg in a way that it will not slip past the coronet bone of an equine leg and thereby hold the leg and boot together so that when an equine lifts it legs the boot is also lifted.

9. The boot assembly of claim 1 comprising boot sides and bottom of water retaining fabric, a sole plate that is semi-rigid and has a solid bottom and side walls extending entirely around the circumference of the sole plate and means to removably an elastomeric pad to the inside bottom of the reservoir and a removable elastomeric shock absorbing pad has a top, side, bottom, top front and top rear and is ridged on the top side or is a shock absorbing pad having a front bumper projection on the top front and separate side clip projections on the top sides.

10. A method of simulating gaited movement of an equine animal comprising:
placing at least one of the equine animal's hooves inside each of one or more boot assemblies comprising a boot having a reservoir made of a flexible material for containing coolant and having a closed inside bottom, an underside bottom, an open top, an underside and having an attached sole plate having a bottom, inside top side and side walls into which the closed inside bottom of the reservoir is disposed and attached to the underside of the;
a removable elastomeric shock absorbing pad disposed inside the boot and having pressure pulsing means disposed under or within the shock absorbing pad, and
passing a fluid into and out of the pressure pulsing means to expand and deflate said pressure pulsing means in sequence.

11. The method of claim 10 wherein the means of passing fluid into and out of the pressure pulsing means that are disposed under or within the shock absorbing pad that comprises a fluid pump, inlet valves to force fluid to pass by conduit to each of one or more multiple boot assemblies having pulsing means to inflate the pressure pulsing means and outlet valves to allow the fluid to flow to a reservoir, thus deflating the pressure pulsing means and wherein the fluid pump, pulsing means, inlet valves and outlet valves are automated with a controller to provide timing and sequencing of inflation and deflation of the pressure pulsing means to simulate gaits of an equine animal.

12. The method of claim 10 wherein the removable elastomeric shock absorbing pad has a top, side, bottom, top front and top rear and is ridged on the top side or is a shock absorbing pad having a front bumper projection on the top front and separate side clip projections on the top sides.

13. The method of claim 10 wherein the boot sole plate is fitted with a rocker attachment.

14. A method of treatment of equine hooves and legs needing treatment comprising fitting an equine animal leg that will benefit from cryotherapy treatment into a boot assembly comprising a boot comprising a reservoir made of a flexible material for containing coolant, filling the boot assembly reservoir with coolant for sufficient time and at a sufficient temperature to effect measurable cooling of the leg and hoof wherein the boot assembly comprises:
a reservoir made of a flexible material for containing coolant having side walls, a closed inside bottom, an underside bottom and open top, an underside and having a sole plate having a bottom, inside top side and side walls into which the closed inside bottom of the reservoir is disposed and attachment means to attach the underside of the reservoir to the inside top side of the sole plate;
a removable elastomeric shock absorbing pad disposed inside the boot in the bottom of the reservoir on top of a layer of reservoir material and having pressure pulsing means disposed under or within the shock absorbing pad, and
means for injecting air into coolant in the reservoir.

15. The method of claim 14 comprising providing means to removably connect the boot to an equine leg, said means comprising a fabric collar that is designed to removably and adjustably surround an equine leg above the coronet bone of the leg and that has hook and loop straps attached and positioned to allow them to be connected to matching hook and loop straps attached to the inside closed bottom of the boot to enable the fabric collar to be attached to the equine leg in a way that it will not slip past the coronet bone of an equine leg and thereby hold the leg and boot together so that when an equine lifts it legs the boot is also lifted.

16. the removable elastomeric shock absorbing pad has a top, side, bottom, top front and top rear and is ridged on the top side or is a shock absorbing pad having a front bumper projection on the top front and separate side clip projections on the top sides.

17. The method of claim 14 wherein the pulsing means is operated to pulse the elastomeric shock absorbing pads in a predetermined sequence.

18. The method of claim 14 wherein an equine leg is fitted into in the boot assembly for intervals of time of 10 to 30 minutes, removed and allowed to warm.
